(19) United States
(12) Patent Application Publication
(10) Pub. No.: US 2006/0057430 A1
(43) Pub. Date: Mar. 16, 2006

(54) Perpendicular magnetic recording medium

(75) Inventor: Yoshiyuki Kuboki, Tokyo (JP)

Correspondence Address: ROSSI, KIMMS & McDOWELL LLP., P.O. BOX 826, ASHBURN, VA, 20146-0826, US

(73) Assignee: Fuji Electric Device Technology Co., Ltd., Shinagawa-ku (JP)

(21) Appl. No.: 11/223,783

(22) Filed: Sep. 9, 2005

(30) Foreign Application Priority Data
Sep. 9, 2004 (JP) JPPA 2004-262128

(51) Int. Cl. G11B 5/65

(52) U.S. Cl. 428/836.2

(57) ABSTRACT

A perpendicular magnetic recording medium is disclosed that exhibits improved write performance without impairing thermal stability or electromagnetic conversion performance such as noise characteristics. A perpendicular magnetic recording medium of the invention comprises a nonmagnetic underlayer and a granular type magnetic layer. In measurements on ferromagnetic crystal grains by grazing incidence X-ray diffraction, a ratio A/B is in the range of 0.2 to 1.5, in which A represents an integrated intensity of fcc (111) peak obtained with a X-axis angle of 69.5° and B represents an integrated intensity of hcp (101) peak obtained with a X-axis angle of 60.2°. The medium can include a soft magnetic backing layer and a seed layer. The seed layer preferably is a lamination of a layer with an amorphous structure and a layer with a crystal structure of fcc or hcp.

### CROSS REFERENCE TO RELATED APPLICATIONS

This application is based on, and claims priority to, Japanese Application No. 2004-262128, filed on Sep. 9, 2004, the contents of which are incorporated herein by reference.

### BACKGROUND OF THE INVENTION

A. Field of the Invention

The present invention relates to a perpendicular magnetic recording medium for read-write of information, in particular, to a perpendicular magnetic recording medium housed in hard disk drives (HDDs).

B. Description of the Related Art

Currently, magnetic recording media employ a longitudinal recording method, in which a magnetic layer of a cobalt alloy or the like is provided over a substrate through an underlayer composed of chromium, chromium alloy or the like, and the direction of recorded magnetization is in the plane of the substrate. As the need for high recording density of magnetic recording media is increasing year after year, research and development of perpendicular magnetic recording media are being carried out actively that are suited for the high density recording.

It is necessary to promote magnetic isolation between ferromagnetic crystal grains that compose a magnetic layer and to minimize a magnetization reversal unit in order to improve electromagnetic conversion characteristics, typically noise performance, and to enhance the recording density. A granular type magnetic layer has drawn attention as being suitable for this purpose. In the granular magnetic layer, ferromagnetic crystal grains of cobalt-based alloy or the like are surrounded by a nonmagnetic grain boundary of oxide or nitride. The nonmagnetic grain boundary has the effects of reducing magnetic interaction between the ferromagnetic crystal grains and minimizing magnetization reversal unit. (See Tadaaki Oikawa et al., “Dependence of magnetic performance on Pt, Cr compositions in a CoPtCr-SiO₂/Ru perpendicular magnetic recording medium” J of Magnetic Society of Japan, 28:254-257 (2004), for example.) The ferromagnetic crystal grains of a cobalt-based alloy have been formed with a crystal structure of hexagonal close-packed structure (hcp). The cobalt-based alloy changes its magnetic property depending on the crystal structure, and the highest coercivity is attained in the hcp structure. Accordingly, it has been believed that the hcp structure is optimal for achieving best magnetic performance and the face-centered cubic structure (fcc) and other crystal structures are to be excluded because of poor magnetic performance. (See Japanese Unexamined Patent Application Publication No. H6-96950, for example.)

As the magnetization reversal unit is decreased in order to promote high density recording by improving noise performance and other properties, a phenomenon called “thermal fluctuation” has become noticeable. The thermal stability (resistance to the thermal fluctuation) of a magnetic body is represented by an index KuVa, a product of a uniaxial anisotropy constant Ku and an activation volume Va, which is known to correlate with the volume V of a magnetization reversal unit. The thermal stability of a magnetic recording medium deteriorates as the KuVa (or KuV) decreases. As is clear from this index, the thermal stability deteriorates when the magnetization reversal unit is reduced to enhance recording density. Consequently, the problem of thermal fluctuation still arises even in a perpendicular magnetic recording medium. In order to ensure thermal stability even with a small magnetization reversal unit, the Ku must be increased.

On the other hand, it is known that a magnetic field intensity required by recording in an HDD is approximately proportional to the Ku value. When the magnetic interaction between ferromagnetic crystal grains is sufficiently reduced, as in the case of a granular film in particular, the magnetic field value required for reversing the magnetization of a ferromagnetic crystal grain is known to approach an anisotropy field Hk. The Hk is represented by Hk=2 Ku/Ms, where Ms is a saturation magnetization of the ferromagnetic crystal grain. When the Ku is increased and the V is decreased to ensure simultaneously the noise performance and thermal stability, the Hk is caused to increase resulting in increase of magnetic field intensity required by recording. If the increase of this magnetic field intensity is significant, recording may become impossible. By decreasing the magnetization reversing unit, the demagnetizing field decreases, which causes an increase in the reversing field. Thus, the magnetic field intensity required for recording increases as the magnetization reversing unit reduces.

Although the miniaturization of magnetization reversal unit and the enhancement of Ku directing to high density recording contribute to improvement of thermal stability and noise performance of a magnetic recording medium, both lead to a deterioration in write performance (ease of recording on a magnetic recording medium). Based on the foregoing, a method is required that improves thermal stability and electromagnetic conversion characteristics including noise performance without worsening the write performance. The present invention is directed to overcoming or at least reducing the effects of one or more of the problems set forth above.

### SUMMARY OF THE INVENTION

The present invention has been made in view of the above problems and an object of the invention is to provide a perpendicular magnetic recording medium that improves write performance without impairing thermal stability and electromagnetic conversion characteristics, including noise performance.

To achieve the above objective, the inventors have made extensive studies and solved the above described problems and accomplished the invention by incorporating an appropriate proportion of fcc structure in ferromagnetic crystal grains composing a magnetic layer.

Specifically, a perpendicular magnetic recording medium of the invention comprises at least a nonmagnetic underlayer and a magnetic layer sequentially laminated on a nonmagnetic substrate. The magnetic layer comprises ferromagnetic crystal grains composed of a cobalt-based alloy and nonmagnetic grain boundary composed mainly of oxide. In measurement on the ferromagnetic crystal grains by grazing incidence X-ray diffraction, a ratio A/B is in a range of 0.2 to 1.5, in which A represents an integrated intensity of fcc (111) peak obtained at a χ-axis angle of 69.5° and B represents an integrated intensity of hcp (101) peak obtained at a χ-axis angle of 60.2°.

Advantageously, a seed layer is provided between the nonmagnetic substrate and the nonmagnetic underlayer. The seed layer preferably has a crystal structure of fcc or hcp. More preferably, the seed layer is formed by laminating a layer with an amorphous structure and a layer with a crystal structure of fcc or hcp in this order. The seed layer preferably contains at least an element selected from Nb, Mo, Ta, W, Cr, Zr, Ni, Ti, Fe, Co, Si, B, and P.

The nonmagnetic underlayer preferably contains at least one element selected from Ru, Re, Ti, Zr, Nd, Tm, Hf, and Os. The nonmagnetic underlayer more preferably contains Ru or Re, and further contains at least one element selected from Ti, Zr, Nd, Tm, Hf, Os, Si, P, B, C, and Al. The nonmagnetic underlayer has a thickness preferably in a range of 3 nm to 20 nm.

Advantageously, the magnetic layer comprises a CoPt-based alloy containing Pt in a range of 5 at % to 26 at % and an oxide occupying from 5 mol % to 15 mol % of the magnetic layer. The oxide in the magnetic layer is preferably selected from SiO₂, Cr₂O₃, ZrO₂, and Al₂O₃.

Advantageously, a soft magnetic backing layer is provided between the nonmagnetic substrate and the seed layer. The nonmagnetic substrate can be composed of aluminum, glass, or plastic resin. A perpendicular magnetic recording medium as constructed in the above-described structure exhibits low noise and high thermal stability and at the same time, good write performance.

The best mode of embodiment of the invention will be described in detail hereinafter with reference to the accompanying drawings.

### BRIEF DESCRIPTION OF THE DRAWINGS

The foregoing advantages and features of the invention will become apparent upon reference to the following detailed description and the accompanying drawings, of which:

FIG. 1 is a schematic sectional view of an example of a structure of a perpendicular magnetic recording medium of an embodiment according to the invention;

FIG. 2 shows the dependence of the output decay on the ratio A/B; and

FIG. 3 shows the dependence of the normalized noise on the ratio A/B.

### DETAILED DESCRIPTION OF SPECIFIC EMBODIMENTS

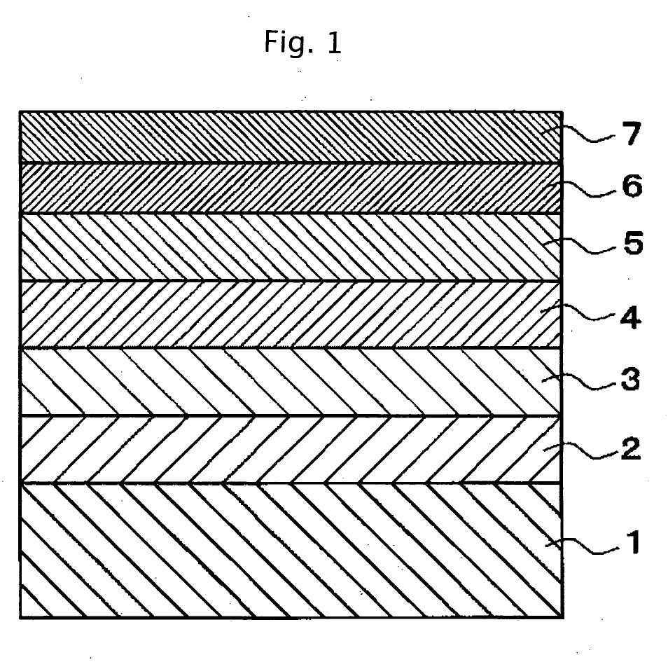

FIG. 1 is a schematic drawing illustrating an example of a perpendicular magnetic recording medium of an embodiment according to the invention. The medium comprises nonmagnetic substrate 1, and soft magnetic backing layer 2, seed layer 3, nonmagnetic underlayer 4, and magnetic layer 5 sequentially formed on substrate 1. In addition, protective layer 6 and liquid lubricating layer 7 are provided on magnetic layer 5.

The essential feature of a perpendicular magnetic recording medium of the invention exists in the construction of the magnetic layer. The magnetic layer of the invention comprises ferromagnetic crystal grains of a cobalt-based alloy and a nonmagnetic grain boundary composed mainly of oxide, and the ferromagnetic crystal grains incorporate an appropriate proportion of a cobalt-based alloy with an fcc structure (hereinafter represented as an fcc-cobalt-based alloy phase) among a cobalt-based alloy with an hcp structure (hereinafter represented as an hcp-cobalt-based alloy phase). By this construction, write performance is improved while low noise and high thermal stability are maintained. The following is a more detailed description.

Nonmagnetic substrate 1 can be a substrate commonly used in a magnetic recording medium, composed of, for example, an aluminum alloy having a NiP plating, strengthened glass, or crystallized glass. When the temperature of substrate heating is controlled within 100° C., a plastic substrate consisting of a material such as polycarbonate resin or polyolefin resin also can be used.

A soft magnetic backing layer prevents spreading of the magnetic flux generated by a magnetic head in the recording process and ensure a perpendicular magnetic field. Soft magnetic backing layer 2 preferably is provided, though not essential for recording. A material for the soft magnetic backing layer can be selected form a nickel alloy, an iron alloy, an amorphous cobalt alloy, and the like. In particular, amorphous cobalt alloys including CoZrNb and CoTaZr provide favorable electromagnetic conversion characteristics. The thickness of the soft magnetic backing layer is adjusted corresponding to the structure and characteristics of a magnetic head used in recording, and selected in the range of 10 nm to 300 nm in consideration of productivity.

Seed layer 3 is preferably provided for favorably controlling the crystal structure of the magnetic layer. Seed layer 3 is formed in a single layer or a lamination of plurality of layers. In the case of a single layer, the seed layer is formed having a crystal structure of fcc or hcp. This form of a seed layer is hereinafter referred to as a, crystalline seed layer. In the case of laminated layers, a layer with an amorphous structure (hereinafter refereed to as an amorphous seed layer) is first formed, and then a crystalline seed layer is formed. The laminated layer is more effective.

An amorphous seed layer flattens possible irregularities on the surface of the soft magnetic backing layer, and improves alignment of a crystalline seed layer. So, the amorphous seed layer can be omitted when the surface of the soft magnetic backing layer is smooth. An amorphous seed layer preferably contains at least one element selected from Nb, Mo, Ta, W, Cr, Zr, Ni, Ti, Fe, Co, Si, B, and P. Particularly favorable materials to obtain a good amorphous structure include Ta, TaNi, TaNiB, TiCr, NiNb, and CrB. Thickness of an amorphous seed layer is preferably selected in a range of 2 nm to 10 nm. A thickness smaller than 2 nm does not have a smoothing effect to the surface irregularity, and causes poor alignment of a crystalline seed layer. A thickness larger than 10 nm lowers the output signal because of an elongated distance between the soft magnetic backing layer and the magnetic head.

The crystalline seed layer is provided to improve grain size distribution and alignment of the above formed nonmagnetic underlayer 4. A crystalline seed layer preferably contains at least one element selected from Nb, Mo, Ta, W, Cr, Zr, Ni, Ti, Fe, Co, Si, B, and P. A composition of the crystalline seed layer is appropriately determined by considering the lattice constant of the nonmagnetic underlayer material. To obtain good alignment of the above-formed nonmagnetic underlayer 4 and good perpendicular alignment of the axis of easy magnetization in magnetic layer 5, a material of the crystalline seed layer preferably has an fcc or hcp structure, in particular, with the fcc (111) plane or the hcp (002) plane aligning in parallel to the nonmagnetic substrate surface. By minimizing the grain size of the crystalline seed layer, the grain sizes of the nonmagnetic underlayer and the ferromagnetic crystal grains of the magnetic layer also can be minimized. Addition of boron or phosphorus can reduce the grain size of the crystalline seed layer. The amount of the additive is appropriately selected considering the Ku value determined by the composition of magnetic layer 5 and the size of the ferromagnetic crystal grains that is expected to avoid thermal fluctuation, taking the thickness of the magnetic layer into account. The thickness of the crystalline seed layer is preferably in a range of 5 nm to 20 nm. A thickness less than 5 nm fails to obtain favorable fcc (111) or hcp (002) alignment, deteriorating alignment in underlayer 4 and magnetic layer 5. A thickness more than 20 nm swells the grains of the crystalline seed layer resulting in swelling of the grains in above-formed underlayer 4 and magnetic layer 5, which causes noise enhancement.

Nonmagnetic underlayer 4 regulates generation of the fcc-cobalt-based alloy phase in magnetic layer 5, improves perpendicular alignment in the magnetic layer, and suppresses the initial growth layer of the magnetic layer. Nonmagnetic underlayer 4 preferably contains at least one element selected from Ru, Re, Ti, Zr, Nd, Tm, Hf, and Os. More preferably, the nonmagnetic underlayer is composed of an alloy consisting mainly of Ru or Re and further containing, corresponding to the lattice constant of magnetic layer 5, at least one element selected from Ti, Zr, Nd, Tm, Hf, Os, Si, P, B, C, and Al. A thickness of nonmagnetic underlayer 4 is preferably in a range of 3 nm to 20 nm. A thickness less than 3 nm fails to achieve good crystallinity, which deteriorates alignment in nonmagnetic underlayer 4 and alignment in magnetic layer 5, and further, promotes generation of the initial growth layer in magnetic layer 5. A thickness more than 20 nm accelerates growth of the hcp-cobalt-based alloy phase and thus, interferes with incorporation of an appropriate proportion of fcc-cobalt-based alloy phase. In addition, the grain size of nonmagnetic underlayer 4 swells, resulting in swelling of the grain size of magnetic layer 5, which invites an increase in noise.

Magnetic layer 5, a layer for recording information, necessarily has an axis of easy magnetization aligning perpendicularly to the substrate surface for use in a perpendicular magnetic recording medium. Preferably, the crystal lattice plane of hcp (002) aligns in parallel to the substrate surface. Magnetic layer 5 has a so-called granular structure in which ferromagnetic grains of a cobalt-based alloy are surrounded by nonmagnetic grain boundary mainly consisting of oxide. The granular structure reduces noise level. Here, the wording “mainly consisting of” does not inhibit inclusion of small amounts of other components, and means that the oxide exists in a proportion of more than about 90 mol % of the nonmagnetic grain boundary.

A cobalt-based alloy composing the ferromagnetic crystal grains can be selected from CoPt-based alloys including CoPtCr, CoPt, CoPtSi, and CoPtCrB, and CoCr-based alloys including CoCr, CoCrTa, and CoCrTaPt. A CoPt-based alloy is preferable because high Ku value can be established.

The oxide can be selected from SiO₂, Cr₂O₃, ZrO₂, and Al₂O₃, which exhibit favorable magnetic isolation between ferromagnetic crystal grains of cobalt-based alloy. The SiO₂ is preferably used because of superior functionality of magnetic isolation between ferromagnetic crystal grains consisting of CoPt-based alloy.

An appropriate proportion of an fcc crystal structure is incorporated in the ferromagnetic crystal grains to achieve thermal stability, noise performance, and write performance simultaneously. In measuring the crystal structure of the ferromagnetic crystal grains by 2θ scanning of grazing incidence X-ray diffraction, provided A is an integrated intensity of an fcc (111) peak obtained at a X-axis angle of 69.5° and B is an integrated intensity of hcp (101) peak obtained at a X-axis angle of 60.2°, the ratio A/B ranges from 0.2 to 1.5 in the present invention.

If the proportion of the fcc-cobalt-based alloy phase increases to an extent of A/B over 1.5, thermal stability worsens to an unacceptable level in practical application although write performance improves. This is because a Ku value of a cobalt-based alloy is different between an hcp-cobalt-based alloy phase and an fcc-cobalt-based alloy phase. More specifically, the Ku value is lower in the fcc-cobalt-based alloy phase. As the proportion of fcc-cobalt-based alloy phase increases, the KuV, an index of thermal stability, decreases in terms of the property of overall magnetic layer, thus worsening thermal stability.

When the proportion of the fcc-cobalt-based alloy phase decreases and the ratio A/B becomes less than 0.2, the result is one of the following:
1) while thermal stability is good, the noise performance or the write performance degrades to a practically unacceptable level, or
2) while write performance is good, the noise performance or the thermal stability degrades to a practically unacceptable level.

Either of the two may occur, depending on the composition of the ferromagnetic crystal grains composing the magnetic layer, the proportion of nonmagnetic grain boundary in the magnetic layer, and the structure of the nonmagnetic underlayer. In any case, a ratio A/B less than 0.2 can hardly achieve thermal stability, noise performance, and write performance simultaneously in a practically acceptable level.

The proportion of fcc-cobalt-based alloy phase can be regulated by the composition of ferromagnetic crystal grains composing the magnetic layer, the proportion of nonmagnetic grain boundary in the magnetic layer, and the structure of the nonmagnetic underlayer. The quantity of additive elements to the cobalt-based alloy can regulate the proportion of fcc-cobalt-based alloy phase. The amount of addition, also affecting the Ku and coercivity, is appropriately adjusted according to desired property. When platinum is added to cobalt, for example, platinum is preferably added in a range of 5 to 26 at % of the cobalt-based alloy. With an increase of added platinum, the quantity of fcc-cobalt-based alloy phase increases provided other conditions are fixed. If the platinum content is less than 5 at %, the fcc-cobalt-based alloy phase is formed insufficiently. A Ku value of the hcp-cobalt-based alloy phase being small, thermal stability cannot be secured, though write performance is favorable. When the quantity of added platinum exceeds 26 at % inma granular type magnetic layer, while a Ku value of the hcp-cobalt-based alloy phase improves, too much fcc-cobalt-based alloy phase is formed, resulting in decrease of a Ku value of the magnetic layer as a whole. As a result, thermal stability cannot be secured although write performance is favorable.

The quantity of the oxide composing the nonmagnetic grain boundary can also regulate the proportion of fcc-cobalt-based alloy phase. The quantity of oxide, also affecting the Ms and coercivity, is appropriately adjusted according to desired property. The oxide is preferably contained in a range of 5 to 15 mol % in the magnetic layer. If the amount of oxide is less than 5 mol %, the fcc-cobalt-based alloy phase is formed insufficiently and isolation of ferromagnetic crystal grains is insufficient. As a result, the noise performance and the write performance are poor, while high thermal stability is attained. When the oxide content is larger than 15 mol %, the nonmagnetic grain boundary expands and the grain sizes of the ferromagnetic crystal grains shrink. In the region where the grain size is too minimized, the formation of fcc-cobalt-based alloy phase is excessively promoted. As a result, thermal stability cannot be ensured, while noise performance and write performance are favorable.

As described previously, the proportion of fcc-cobalt-based alloy phase can also be regulated by the structure of nonmagnetic underlayer 4. The proportion of fcc-cobalt-based alloy phase can be regulated by conditions including the sputtering power and the gas pressure in the process of depositing the layers from seed layer 3 through magnetic layer 5.

The thickness of the magnetic layer 5 is selected in consideration of the balance between the write capability of a magnetic head and thermal stability, and is preferably in a range of 5 nm to 20 nm.

Protective layer 6 can be a commonly employed protective layer for example, a protective layer composed mainly of carbon. The thickness of protective layer 6 can be the thickness employed in a common magnetic recording medium. Lubricating layer 7 can likewise use a common material for example, a perfluoropolyether lubricant. A thickness of lubricating layer 7 can be the thickness employed in a common magnetic recording medium.

The following describes perpendicular magnetic recording media according to the invention more in detail referring to specific embodiment examples. It should be understood that the invention is not limited to the examples but various modifications are possible within the spirit and scope of the invention.

### EXAMPLE 1

Example 1 and Comparative Examples 1 and 2 were manufactured employing the structure of FIG. 1, varying the quantity of platinum added in the magnetic layer.

Nonmagnetic substrate 1 used was a disk-shaped chemically strengthened glass substrate (N-10 glass substrate manufactured by HOYA Corporation) having a diameter of 65 mm and a thickness of 0.635 mm. After cleaning, the substrate was introduced into a sputtering apparatus, and soft magnetic backing layer 2 of amorphous CoZrNb 200 nm thick was deposited using a target of Co8Zr5Nb (the numerals are in atomic percent and represent 8 at % of zirconium, 5 at % of niobium, and the remainder of cobalt; the notation is similarly applicable in the following description). Subsequently, amorphous seed layer 5 nm thick was deposited of tantalum. Then, seed layer 3 was formed by depositing a crystalline seed layer 5 nm thick using a target of Ni12Fe8B. Subsequently, nonmagnetic underlayer 4 having a thickness of 10 nm was deposited using a target of ruthenium under an argon gas pressure of 4.0 Pa. Then, magnetic layer 5 having a thickness of 15 nm was formed using a target of 90 mol % (Co8Cr16Pt)—10 mol % SiO₂ under an argon gas pressure of 4.0 Pa. Subsequently, carbon protective layer 6 having a thickness of 5 nm was formed by means of CVD. Then, the substrate having the deposited layers was taken out of the vacuum chamber. The deposition of these layers except for the carbon protective layer was carried out by a DC magnetron sputtering method. After that, liquid lubricating layer 7 of perfluoropolyether having a thickness of 2 nm was formed by a dipping method. Thus, a perpendicular magnetic recording medium of Example 1 was manufactured.

### COMPARATIVE EXAMPLE 1

Comparative Example 1 was manufactured in the same manner as in Example 1 except that the composition of a target for a magnetic layer was 90 mol % (Co8Cr2Pt)—10 mol % SiO₂.

### COMPARATIVE EXAMPLE 2

Comparative Example 2 was manufactured in the same manner as in Example 1 except that the composition of a target for a magnetic layer was 90 mol % (Co8Cr30Pt)—10 mol % SiO₂.

### EXAMPLE 2

Example 2 and Comparative Examples 3 and 4 were manufactured varying amounts of SiO₂, Pt, and Cr in a magnetic layer.

Example 2 was manufactured in the same manner as in Example 1 except that the composition of a target for the magnetic layer was 85 mol % (Co10Cr25Pt)—15 mol % SiO₂.

### COMPARATIVE EXAMPLE 3

Comparative Example 3 was manufactured in the same manner as in Example 1 except that the composition of a target for the magnetic layer was 82 mol % (Co8Cr16Pt)—18 mol % SiO₂.

### COMPARATIVE EXAMPLE 4

Comparative Example 4 was manufactured in the same manner as in Example 1 except that the composition of a target for the magnetic layer was Co8Cr30Pt.

### EXAMPLE 3

Example 3 used an oxide of Cr₂O₃. Example 3 was manufactured in the same manner as in Example 1 except that the composition of a target for the magnetic layer was 90 mol % (Co5Cr16Pt)—10 mol % Cr₂O₃.

### EXAMPLE 4

Example 4 used CoSiPt for a material of ferromagnetic crystal grains. Example 4 was manufactured in the same manner as in Example 1 except that the composition of a target for the magnetic layer was 90 mol % (Co4Si16Pt)—10 mol % SiO₂.

### EXAMPLE 5

Example 5 used rhenium for a material of nonmagnetic underlayer. Example 5 was manufactured in the same manner as in Example 1 except that a nonmagnetic underlayer 15 nm thick was formed using a rhenium target and the composition of a target for the magnetic layer was 88 mol % (Co8Cr20Pt)—12 mol % SiO₂.

### EXAMPLE 6

Example 6 had a seed layer 3 consisting of a single layer of a crystalline seed layer. Example 6 was manufactured in the same manner as in Example 1 except that an amorphous seed layer of tantalum was not formed.

### COMPARATIVE EXAMPLE 5

Comparative Example 5 had a thick nonmagnetic underlayer. Comparative Example 5 was manufactured in the same manner as in Example 1 except that a nonmagnetic underlayer having a thickness of 30 nm was formed using a ruthenium target.

Performance for Examples 1 through 6 of the invention and the Comparative Examples 1 through 5 was evaluated. Measurements were made on coercivity (Hc), normalized noise, overwrite (O/W), output decay, and A/B in the Examples and Comparative Examples, the results of which are given in Table 1.

TABLE 1

| | | normalized | | | |
|---|---|---|---|---|---|
| | | noise | O/W | output decay | |
| | Hc (kA/m) | (μVᵣₘₛ/mVₚₚ) | (dB) | (%/decade) | A/B |
| Example 1 | 372.6 | 25 | 36 | 0.26 | 0.25 |
| Example 2 | 338.3 | 21 | 42 | 0.28 | 1.48 |
| Example 3 | 358.7 | 26 | 40 | 0.31 | 0.21 |
| Example 4 | 382.6 | 27 | 37 | 0.25 | 0.45 |
| Example 5 | 330.8 | 26 | 41 | 0.29 | 0.48 |
| Example 6 | 342.7 | 27 | 38 | 0.25 | 0.26 |
| Comp Ex 1 | 157.8 | 28 | 47 | 0.85 | 0.15 |
| Comp Ex 2 | 271.8 | 32 | 45 | 0.75 | 1.95 |
| Comp Ex 3 | 63.8 | 20 | 51 | 1.25 | 1.90 |
| Comp Ex 4 | 181.7 | 42 | 25 | 0.15 | 0.08 |
| Comp Ex 5 | 558.9 | 30 | 28 | 0.18 | 0.14 |

The coercivity was measured with a Kerr effect magnetometer. The normalized noise was measured by a spinning stand tester equipped with a GMR head at a linear recording density of 400 kFCl (kilo flux change per inch). The O/W was measured by the spinning stand tester employing the value overwritten with 45 kFCl signals over 340 kFCl signals. The output decay was measured by the spinning stand tester at a linear recording density of 300 kFCl and at a temperature of 60° C. The A/B was measured on an undulator beam line BL16XU in a large synchrotron radiation facility Spring8 (Super Photon ring—8 GeV). The measuring method was a grazing incidence X-ray diffraction using a 4-axis diffractometer with X-ray energy of 10 keV (wavelength: 0.124 nm), incident angle in a total reflection condition (0.20°), incident slit of 0.1 mm (horizontal direction)×1 mm (vertical direction), receiving silt of double slit, and a detector of scintillation counter. The 2θ scanning was conducted with a X-angle of 69.5° for detection of fcc (111) and X-angle of 60.2° for detection of hcp (101).

The O/W is an index of write performance. Values not smaller than 30 dB are acceptable in practical application. The output decay is an index of thermal stability. The upper limit of the output decay is commonly considered to be 5% in 5 years, which corresponds to about 0.6%/decade. The absolute value of normalized noise varies depending on the linear recording density for the same medium. Under the conditions in these measurements, values not larger than 27 μVᵣₘₛ/mVₚₚ raise no practical problem; here, “rms” stands for root mean square and “pp” stands for peak to peak.

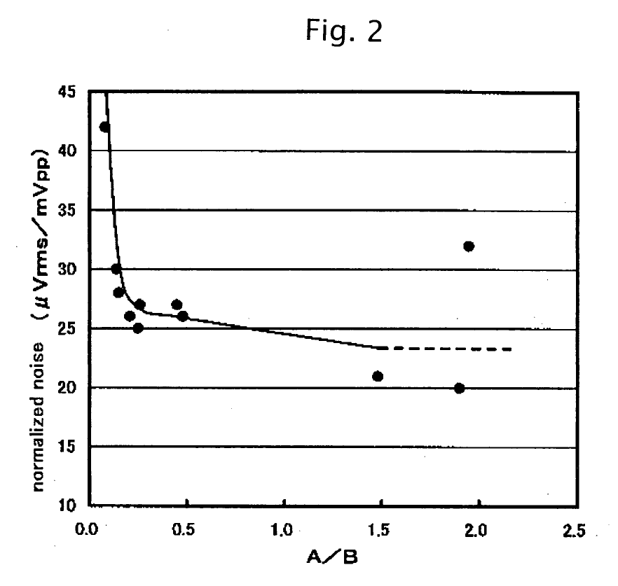

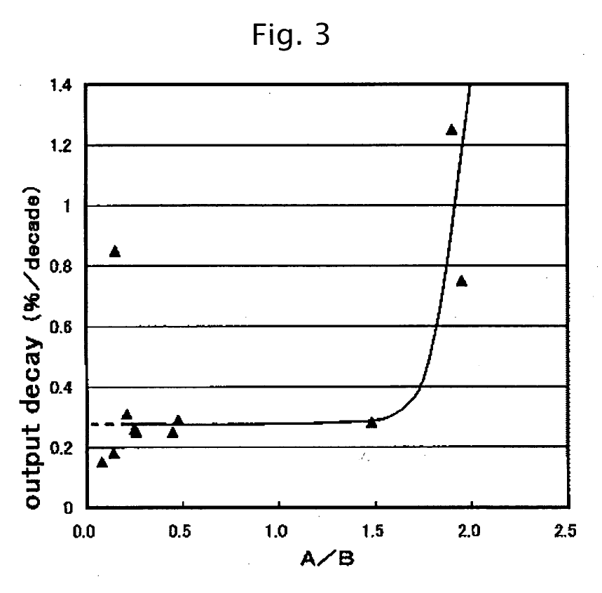

FIG. 2 shows the dependence of output decay on A/B in the perpendicular magnetic recording media of Examples 1 through 6 and Comparative Examples 1 through 5. FIG. 3 shows the dependence of normalized noise on A/B.

Referring to FIG. 2, it can be seen that the output decay abruptly rises with an increase of A/B beyond 1.5, to a value that is unacceptable for practical use. In the range of A/B from 0.2 to 1.5, the output decay is low. When A/B is smaller than 0.2, the output decay changes its value depending on the structure of the perpendicular magnetic recording medium. Details on this point will be described later.

FIG. 3 shows that normalized noise abruptly increases with decrease of A/B below 0.2. In the range of A/B from 0.2 to 1.5, the normalized noise is small. When the A/B is larger than 1.5, the normalized noise changes its value depending on the structure of the perpendicular magnetic recording medium. Details on this point will be described later.

Comparing Example 1 with Comparative Examples 1 and 2, it can be seen that variation in the quantity of platinum added in the cobalt-based alloy changes A/B, and with an increase of the quantity of platinum under the fixed other conditions, the A/B increases. Various characteristics change accompanying the change of A/B. Example 1, in which A/B is 0.25, exhibits favorable normalized noise, O/W, and output decay. On the other hand, Comparative Example 1, in which the quantity of platinum is less than Example 1, exhibited A/B of 0.15. As mentioned previously, when the A/B is less than 0.2, two cases occur. In the case of Comparative Example 1, O/W is favorable, normalized noise increases, and output decay deteriorated significantly. This can be considered that the small content of platinum lowered the Ku value of the hcp-cobalt-based alloy phase. In Comparative Example 2, in which platinum content was increased, the output decay also deteriorated as compared with Example 1, though not as significantly as in Comparative Example 1. In Comparative Example 2, the fcc-cobalt-based alloy phase so increased that the A/B exceeded 1.5 and the coercivity decreased, resulting in the deterioration of output decay.

Next, the effect of the amount of SiO₂ added in the magnetic layer is considered. Comparing Example 1 with Comparative Example 3, and Comparative Example 2 with Comparative Example 4, it can be seen that the A/B changes with the change of the quantity of SiO₂ and the A/B increases with increase of the quantity of SiO₂ under the same other conditions. With the increase of A/B, the O/W improves.

Comparative Example 3, in which the SiO₂ content is larger than in Example 1, exhibited favorable O/W and normalized noise, but significantly increased output decay. Seeing the noticeable decrease in coercivity, the deterioration of output decay can be attributed to a too greatly minimized size of the ferromagnetic crystal grains. It has been clarified that excessive addition of SiO₂, to increase the A/B too much, worsens thermal stability.

Composition of the magnetic layer in Comparative Example 4 contains no oxide phase of SiO₂. While two cases occur when A/B is smaller than 0.2 as described previously, Comparative Example 4 exhibited favorable output decay, increased normalized noise, and lowered O/W. This can be caused by large Ku value due to addition of 30 at % of platinum and by degradation of isolation of ferromagnetic crystal grains from each other due to absence of SiO₂. A low value of coercivity can be attributed to the degradation of isolation. It has been certified that a magnetic layer without an oxide phase deteriorates write performance and noise performance.

Example 2, in which both platinum content and SiO₂ content were increased as compared to Example 1, exhibited favorable values in all of O/W, output decay, and normalized noise. A/B of Example 2 was 1.48. The proportion of fcc-cobalt-based alloy phase represented by this value of A/B is considered to maintain an appropriate grain size and an isolation structure within a level not to cause thermal fluctuation, achieving favorable performances.

Example 3, comprising an oxide of Cr₂O₃, exhibited favorable values of O/W, output decay, and normalized noise. From this result, it has been confirmed that Cr₂O₃ also provides favorable micro structure in which ferromagnetic crystal grains are surrounded by nonmagnetic grain boundary of oxide.

Example 4, having a composition of ferromagnetic crystal grains of Co4Si16Pt, exhibited favorable values of O/W, output decay, and normalized noise. From this result, it has been confirmed that replacing chromium in ferromagnetic crystal grains by silicon still provides favorable performances.

Example 5 has nonmagnetic underlayer 4 of rhenium. Since rhenium has a larger lattice constant than ruthenium, an adjustment was implemented to increase platinum content in the magnetic layer so as not to obstruct epitaxial growth. Example 5 exhibited favorable values of O/W, output decay, and normalized noise. It has been clarified that favorable performances are achieved in a nonmagnetic underlayer of rhenium as in a ruthenium underlayer, by selecting a composition that does not obstruct epitaxial growth.

Example 6, having a seed layer 3 of a single crystalline seed layer, exhibited favorable values of O/W, output decay, and normalized noise. From this result, it has been confirmed that favorable performances are still achieved with a seed layer of a single crystalline seed layer.

Comparative Example 5 has thick nonmagnetic underlayer 4 of ruthenium. While two cases occur when A/B is less than 0.2, Comparative Example 5 exhibited good output decay, but increased normalized noise and degraded O/W. Seeing the very large value of coercivity, the thick nonmagnetic underlayer of ruthenium is supposed to decrease the dispersion of c-axis perpendicular alignment of the magnetic layer. In addition, the increase of normalized noise suggests swelling of the ferromagnetic crystal grains. It has been clarified that increasing the thickness of nonmagnetic underlayer of ruthenium excessively to decrease A/B too much, deteriorates noise performance and write performance.

Thus, a perpendicular recording medium has been described according to the present invention. Many modifications and variations may be made to the techniques and structures described and illustrated herein without departing from the spirit and scope of the invention. Accordingly, it should be understood that the methods and devices described herein are illustrative only and are not limiting upon the scope of the invention.

What is claimed is:

1. A perpendicular magnetic recording medium comprising at least a nonmagnetic underlayer and a magnetic layer sequentially laminated on a nonmagnetic substrate, wherein the magnetic layer comprises ferromagnetic crystal grains composed of a cobalt-based alloy and magnetic grain boundary composed mainly of oxide, and has a ratio A/B in a range of 0.2 to 1.5, in which A represents an integrated intensity of fcc (111) peak obtained at a X-axis angle of 69.5° and B represents an integrated intensity of hcp (101) peak obtained at a χ-axis angle of 60.2°, as measured by grazing incidence X-ray diffraction on the ferromagnetic crystal grains.

2. The perpendicular magnetic recording medium according to claim 1, additionally comprising a seed layer between the nonmagnetic substrate and the nonmagnetic underlayer, the seed layer having a crystal structure of fcc or hcp.

3. The perpendicular magnetic recording medium according to claim 1, additionally comprising a seed layer between the nonmagnetic substrate and the nonmagnetic underlayer, the seed layer comprising a layer with an amorphous structure and a layer with a crystal structure of fcc or hcp laminated on the layer with the amorphous structure.

4. The perpendicular magnetic recording medium according to claim 2, wherein the seed layer contains at least one element selected from a group consisting of Nb, Mo, Ta, W, Cr, Zr, Ni, Ti, Fe, Co, Si, B, and P.

5. The perpendicular magnetic recording medium according to claim 3, wherein the seed layer contains at least one element selected from a group consisting of Nb, Mo, Ta, W, Cr, Zr, Ni, Ti, Fe, Co, Si, B, and P.

6. The perpendicular magnetic recording medium according to claim 1, wherein the nonmagnetic underlayer contains at least one element selected from a group consisting of Ru, Re, Ti, Zr, Nd, Tm, Hf, and Os.

7. The perpendicular magnetic recording medium according to claim 1, wherein the nonmagnetic underlayer contains Ru or Re and at least one element selected from a group consisting of Ti, Zr, Nd, Tm, Hf, Os, Si, P, B, C, and Al.

8. The perpendicular magnetic recording medium according to claim 1, wherein the nonmagnetic underlayer has a thickness in a range of 3 nm to 20 nm.

9. The perpendicular magnetic recording medium according to claim 1, wherein the magnetic layer comprises a CoPt-based alloy containing Pt in a range of 5 at % to 26 at %, and the oxide occupies from 5 mol % to 15 mol % of the magnetic layer.

10. The perpendicular magnetic recording medium according to claim 1, wherein the oxide in the magnetic layer is selected from the group consisting of SiO₂, Cr₂O₃, ZrO₂, and Al₂O₃.

11. The perpendicular magnetic recording medium according to claim 2, additionally comprising a soft magnetic backing layer between the nonmagnetic substrate and the seed layer.

12. The perpendicular magnetic recording medium according to claim 3, additionally comprising a soft magnetic backing layer between the nonmagnetic substrate and the seed layer.

13. The perpendicular magnetic recording medium according to claim 1, wherein the nonmagnetic substrate is composed of aluminum, glass, or plastic resin.
